(19) United States
(12) Patent Application Publication
(10) Pub. No.: US 2012/0145245 A1
(43) Pub. Date: Jun. 14, 2012

(54) HIGH-PRESSURE GAS SYSTEM FOR STIMULATING MATERIAL MOVEMENT

(76) Inventors: Oded ROSE, Herzlia (IL); Gennadi Kabishcher, Beer-Sheva (IL)

(21) Appl. No.: 12/963,544

(22) Filed: Dec. 8, 2010

(51) Int. Cl. F15D 1/00

(52) U.S. Cl. 137/1; 137/560

(57) ABSTRACT

A system and method for stimulating material movement and removing of deposits build up within industrial installations such as pipes, containers, ducts, boilers, heat-exchangers, silos and the like. The system may include a hose network including a plurality of distribution hoses branching from a central hose, far ends of the distribution hoses connected to openings provided on a wall of a vessel, and a high pressure gas supply system for supplying pressurized gas to the hose network. The system is designed to generate periodic gas blows into the vessel through the plurality of distribution hoses.

### FIELD OF THE INVENTION

The present invention relates to high-pressure gas systems for stimulating material movement.

### BACKGROUND OF THE INVENTION

In many industrial installations handling processes involving various materials, a buildup of deposits is evident on the walls of pipes, containers, ducts, boilers, heat-exchangers and other vessels of these installations. Additionally, in installations where material is designed to flow through pipes and ducts, an occlusion or blockage may occur. In such cases, it may be desired to stimulate the movement of the material.

There are known high-pressure gas impulse systems for cleaning and stimulating flow of material within silos and similar devices such as U.S. Pat. No. 6,630,032 (referred to hereinafter as “Carmi et al.”). Carmi et al disclosed an apparatus for generating gas-borne shock waves in the vicinity of a vessel, thereby to expose a substance accrued on a surface of the vessel to separation forces causing at least partial separation of the substance from the surface, so as to facilitate removal of the at least partially separated substance therefrom. This apparatus operates at high pressures, up to 250 bars, aimed at cleaning heavy build-up of deposits that may occur in various vessels. However, in many installations, in particular processes in which material is conveyed by fluid, gas or liquid, there may be no need for such a powerful effect.

In heavy industry the use of pressurized gas is widely known. It is used for numerous applications. In the same time the application using pressures higher than 10 bar is rare.

### SUMMARY OF THE INVENTION

According to embodiments of the present invention there is provided a high pressure gas system for stimulating material movement within a vessel. The system may include a hose network including a plurality of distribution hoses branching from a central hose, far ends of the distribution hoses may be connected to openings provided on a wall of the vessel, and a high pressure gas supply system for supplying pressurized gas to the hose network, wherein the system may be designed to generate periodic gas blows into the vessel through the plurality of distribution hoses.

Furthermore, according to embodiments of the present invention, the high pressure gas supply system may include a valve connected to the hose network, an actuator for opening and closing the valve, and a gas receiver connected to the hose network through the valve.

Furthermore, according to embodiments of the present invention, the high pressure gas supply system may include a timer and a solenoid configured to control operation of said actuator. Additionally or alternatively, the high pressure gas supply system may include a controller configured to control operation of said actuator.

Furthermore, according to embodiments of the present invention, the high pressure gas supply system may include storage medium for storing computer executable program including code for operating the system for high pressure gas burst, and a processor for executing the computer executable program.

Furthermore, according to embodiments of the present invention, the high pressure gas supply system may include a plurality of flow restrictors, each connected to one of the far ends of the distribution hoses. For example, the flow restrictors may include pulsators.

Furthermore, according to embodiments of the present invention, the pressure of the pressurized gas may range between 30 to 350 bar.

Furthermore, according to embodiments of the present invention, the high pressure gas supply system may include a sensor, for example pressure sensor, flow sensor or proximity sensor, adapted to sense a physical parameter associated with the operation of the hose network.

Furthermore, according to embodiments of the present invention, there is provided a method for stimulating material movement within a vessel. The method may include providing a house network including a plurality of distribution hoses branching from a central hose, far ends of the distribution hoses connected to openings provided on a wall of the vessel, and supplying pressurized gas to the hose network and generating periodic gas blows into the vessel through the plurality of distribution hoses.

Furthermore, according to embodiments of the present invention, the generation of periodic gas blows may include generating periodic gas blasts into the vessel.

Furthermore, according to embodiments of the present invention, the method may include using flow restrictors provided at the far ends of the distribution hoses to generate the gas blasts. For example, the flow restrictors may include pulsators.

Furthermore, according to embodiments of the present invention, the method may include operating a valve connected to the hose network using an actuator, and connecting a gas receiver to the hose network through the valve.

Furthermore, according to embodiments of the present invention, the supplying of the pressurized gas may include supplying pressurized gas under pressure in the rage between 30 to 350 bar.

Furthermore, according to embodiments of the present invention, the method may include using a sensor, for example, pressure sensor, flow sensor and proximity sensor, to sense a physical parameter associated with the operation of the hose network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram illustrating an exemplary high-pressure gas system for stimulating material movement according to embodiments of the present invention;

FIG. 2A is a schematic diagram illustrating exemplary arrangement of hose network according to embodiments of the present invention;

FIG. 2B is a schematic cross section illustrating exemplary arrangements of distribution hoses according to embodiments of the present invention;

FIG. 3 is a schematic diagram illustrating an exemplary computer controlled high-pressure gas system for stimulating material movement according to embodiments of the present invention;

FIG. 4 is a schematic diagram illustrating an exemplary pulsating high-pressure gas system for stimulating material movement according to embodiments of the present invention;

FIGS. 5A and 5B are schematic diagram illustrating an exemplary pulsator in the closed and opened conditions, respectively; and

FIG. 6 is a flowchart illustration of algorithm for operating a high-pressure gas system for stimulating material movement according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time. Throughout the figures and description, similar elements may have same reference numerals.

Embodiments of the present invention may relate to industrial installations such as pipes, containers, ducts, boilers, heat-exchangers, silos and the like, hereinafter referred to as a vessel, handling processes involving flow of various materials such as granulated materials, chunks, sludge, liquids of various viscosities and the like, and combinations thereof, hereinafter generally referred to as “material”.

According to embodiments of the invention, a hose network constructed of high-pressure central hose and a plurality of distribution hoses branching therefrom may be placed alongside (or otherwise arranged to be brought to) a vessel, with the far ends of the distribution hoses connected to openings provided on a wall of the vessel, in vicinity of locations in which material movement is to be stimulated or buildup cleaned. As a valve or tap connected to the hose network opens, high pressurized gas with typical pressure in the range between 30 to 350 bar may flow through the central hose and the distribution hoses into the vessel with high velocity. Such blows of gas may give an additional driving force to the material flowing through the vessel or may remove buildup of deposits if present on the inner walls of the vessel.

According to embodiments of the invention a high pressurized gas source may be connected to the hose network through a central valve or a tap. The central valve or the tap may open and close periodically, enabling periodical buildup of pressure within the hose network that may be periodically released in the form of gas blows into the vessel. Additionally or alternatively, plurality of distributed flow restrictors such as valves, taps, pulsators, apparatuses for generating gas-borne shock waves as disclosed in Carmi et al and other flow restrictors suitable for operating under pressure that ranges between 30 to 350 bar, may be connected at the far end of the distribution hoses. Such flow restrictors may facilitate periodical buildup of pressure within the hose network and periodically release gas bursts into the vessel.

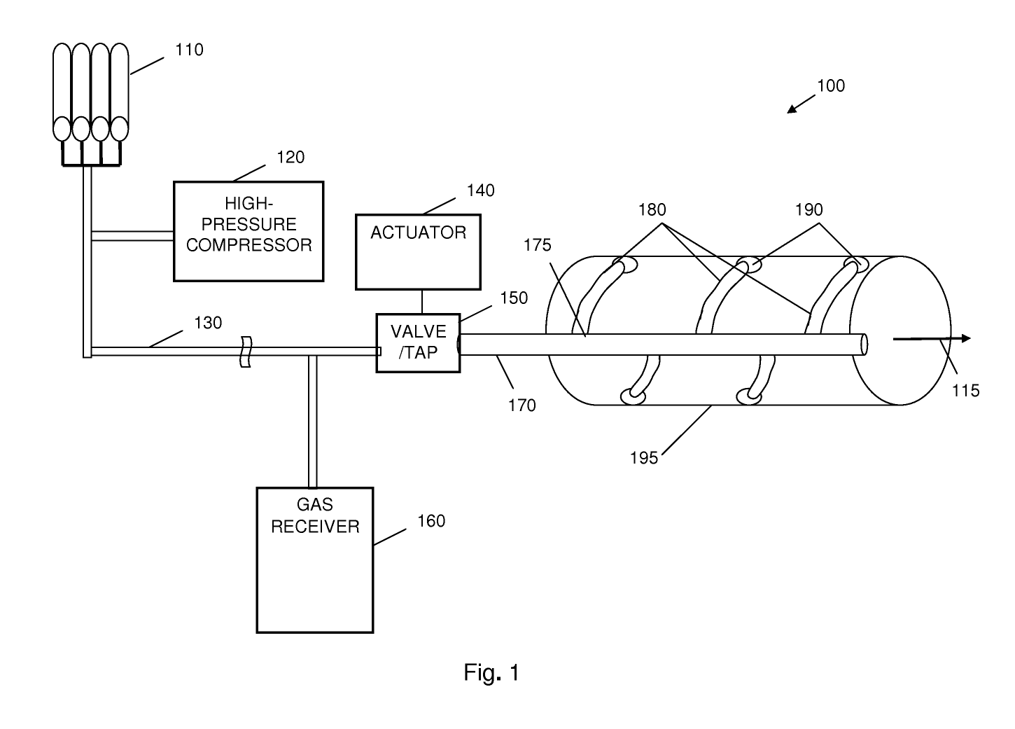

Reference is made to FIG. 1 depicting a schematic diagram illustrating an exemplary high-pressure gas system 100 for stimulating material movement according to embodiments of the present invention. According to embodiments of the present invention, system 100 may include a gas receiver 160 receiving pressurized gas with typical input pressure in the range between 30 to 350 bar, through gas pipeline 130 from a high-pressure gas reservoir, which may include, for example, a high pressure compressor 120 and/or gas bank 110. Gas receiver 160 may be connected to hose network 175 through valve 150. Valve 150 may be controlled by an actuator 140. Hose network 175 may be located along industrial installations, such as a pipe, silo, container, duct, boiler, heat-exchanger or another facility, in vicinity of locations in which material movement should be stimulated or buildup cleaned, such as vessel 195. Hose network 175 may include high-pressure central hose 170, situated along the outer walls of vessel 195, with a plurality of distribution hoses 180 branching out of central hose 170 and into openings 190 provided on a wall of vessel 195. Openings 190 are sealed around distribution hoses 180 such that pressurized gas may flow through distribution hoses 180 and into vessel 195. A unidirectional valve situated in opening 190 may prevent materials from vessel 195 from entering Hose network 175. The general direction of the flow of material in vessel 195 may be indicated by arrow 115.

Typically, high pressure compressor 120 and gas bank 110 may be placed in a central location in the industrial facility that may be relatively far from vessel 195. Because of the resistance of gas pipeline 130, the pressure of the gas may drop as it flows from pressure compressor 120 and gas bank 110 to central hose 170 situated near vessel 195. Therefore, gas receiver 130 may be placed in proximity to central hose 170, keeping the pressure at the entrance of central hose 170 in the high levels of 30 to 350 bar, as known in the art. For example, gas receiver 130 may placed one meter to 15 meters away from central hose 170. The diameter and length of central hose 170 and distribution hoses 180 are such that pressure drop along hose network 175 may be very small or negligible. High pressure compressor 120 may be any compressor capable of compressing gas to levels of 30 to 350 bar, for example, Bauer high-pressure compressors. Gas bank 110 may be any gas bank capable of keeping a volume of 50-250 m3 gas at atmospheric pressure. Gas receiver 130 may be any gas receiver with volume of 2-10 m3. Alternatively, other high pressure gas sources and configurations may be used.

According to embodiments of the present invention, gas bursts may be initiated and terminated by valve or tap 150. As valve or tap 150 opens, high pressure gas may flow through central hose 170 and distribution hoses 180 into vessel 195 with high velocity. Such blows of gas may give an additional driving force to materials being conveyed through vessel 195. Additionally or alternatively, if there is an obstacle to the flow of gas, for example, a buildup of deposits on the walls of vessel 195, the flow of gas may remove the buildup of deposits. The pressure of the gas may increase, creating shear forces on the buildup of deposits. Such shear forces may cause separation and removal of the deposits buildup. Having a plurality of distribution hoses 180 placed along vessel 195 may facilitate cleaning of deposits buildup material movement in various locations along vessel 195 and may eliminate the need to situate a separate cleaning device for each such location.

Actuator 140 may be controlled by the plant central control system (not shown in FIG. 1). Additionally or alternatively, actuator 140 may be controlled by a timer (not shown) and a solenoid (not shown) arrangement. The timer and solenoid may be attached to actuator 140 to regulate valve or tap 150 opening or closing. Additionally or alternatively, valve or tap 150 may be operated manually.

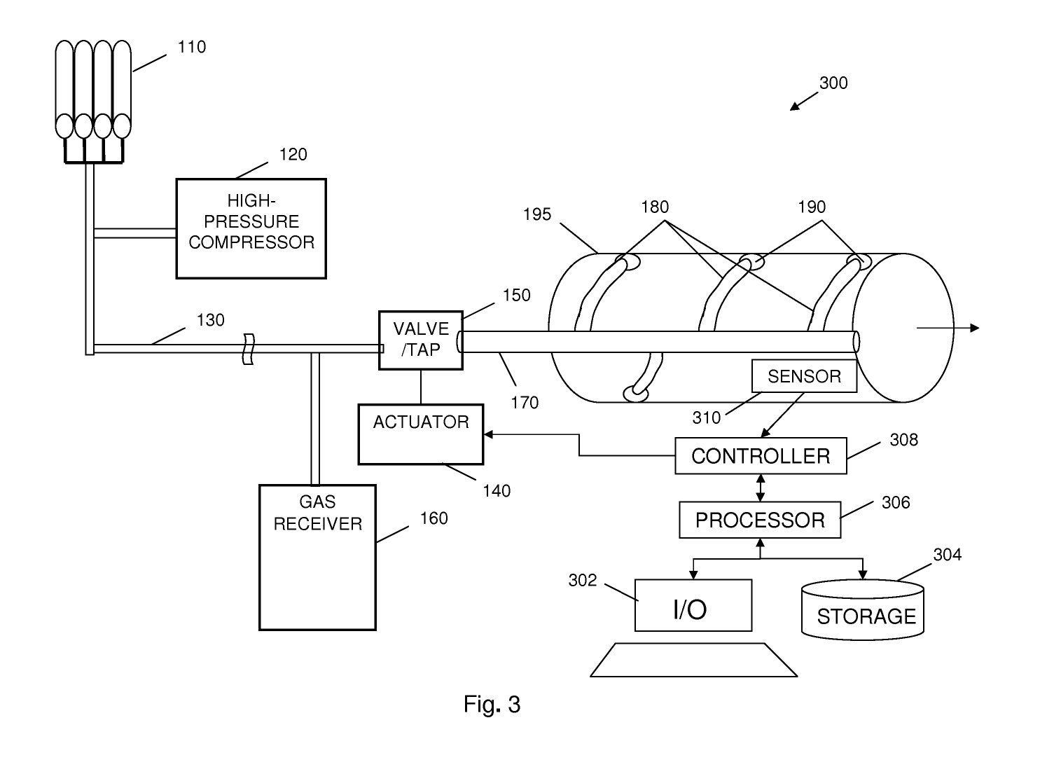

According to embodiments of the present invention the bursts may be given in sequences of short bursts. For example, duration of a short burst may range from 10 seconds to 5 minutes, or from 10 seconds to 1 minute with a pause interval of, for example, several seconds to one minute in between. The short burst may be repeated a predetermined number of times in desired frequency within a sequence. For example, the short burst may be repeated 10 times with frequency of 1-10 repetitions per hour. Additionally, the bursts or sequences of short bursts may repeat every predetermined time interval such as every day, once a week, one a month and the like. Additionally or alternatively, the bursts or sequences of short bursts may be initiated sporadically, manually or automatically, in response to system parameters, as will be explained infra with reference to FIG. 3.

System 100 and its operation may be monitored by an operator or by means of sensors (as will be explained infra with reference to FIG. 3). According to some embodiments of the present invention the operator may adjust operation parameters (such as, for example, pressure, frequency and duration of gas bursts), based on the monitored results.

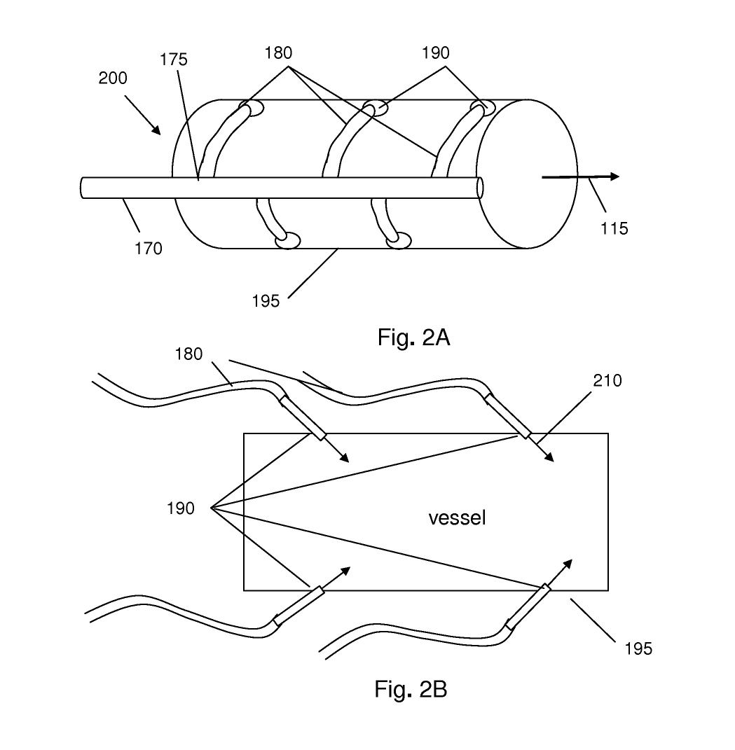

Reference is now made to FIG. 2A depicting schematic diagram illustrating exemplary arrangements of hose network 200 according to embodiments of the present invention. According to the embodiment of the present invention presented in FIG. 2A central hose 170 may be located close to or abutting the outer wall of vessel 195, alternatively, central hose 170 may be located in other configurations with relation to vessel 195, as long as distribution hoses 180 may reach desired locations of vessel 195. Distribution hoses 180 may be rigid or flexible, substantially straight or curved, and may generally stretch along the circumference of outer walls of vessel 195, with the openings directed toward an area or areas in vessel 195 in which buildup should be cleaned or material movement should be stimulated. Flow of gas through hose network 200 and into vessel 195 may create shear forces on the buildup of deposits if exists. Such shear forces may cause separation and removal of the deposits buildup. Additionally or alternatively, flow of gas through hose network 200 and into vessel 195 may give an additional driving force to materials being conveyed through vessel 195.

Reference is now made to FIG. 2B depicting schematic cross section illustrating exemplary arrangements of distribution hoses 180 according to embodiments of the present invention. The general direction of the flow of gas as the gas enters vessel 195 is indicated with arrows 210.

It should be noted that the arrangement of hose network according to embodiments of the present invention may be application and facility specific. The length of central hose 170 and distribution hoses 180, as well as the location of central hose 170 with respect to vessel 195, the number of distribution hoses 180 and other parameters may vary to fit a specific installation or application.

Reference is now made to FIG. 3 depicting a schematic diagram illustrating an exemplary computer controlled high-pressure gas system 300 for stimulating material movement according to embodiments of the present invention. According to embodiments of the present invention, system 300 may be similar to system 100 depicted in FIG. 1. Additionally, computer controlled system 300 my include controller 308, which controls the operation of actuator 140 and valve or a tap 150. One or more sensors 310 may be provided to sense one or more physical parameters associated with the operation of hose network 175. For example, the one or more sensor may include a pressure sensor for sensing pressure changes inside vessel 195, a flow sensor sensing the flow of deposits within vessel 195, a proximity sensor for sensing the thickness of accrued deposits facing distribution hoses 180 or a sensor for sensing changes within vessel 195. Other types of sensors for sensing the above mentioned parameters or other parameters, may also be used. Sensor 310 may send signal to controller 308. Sensor 310 may be used so as to indicate the need for activating flow of gas.

Computer controlled high-pressure gas system 300, according to embodiments of the present invention, may be operated by a computing device running an algorithm. The algorithm may be stored on a storage medium 304, and run on processor 306, which operates controller 308. Optional input/output (I/O) capabilities may be obtained by providing I/O device 302, to allow a user to input data or instructions and to obtain information on the operation of high-pressure gas system 300, e.g. display information on a monitor, obtain a printout from a printer, sound an audio signal from an audio generator.

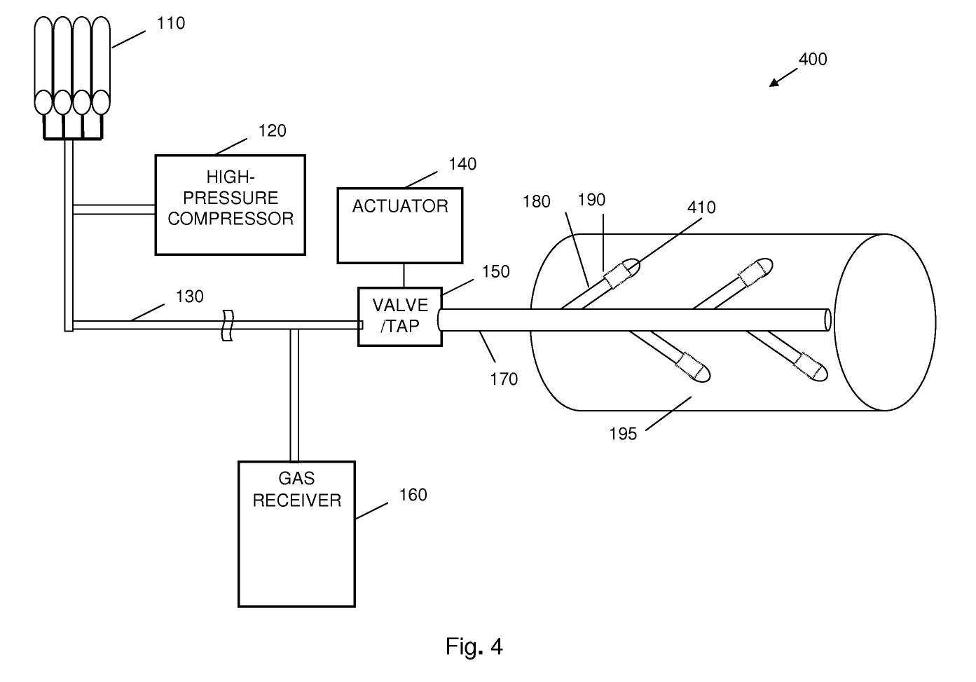

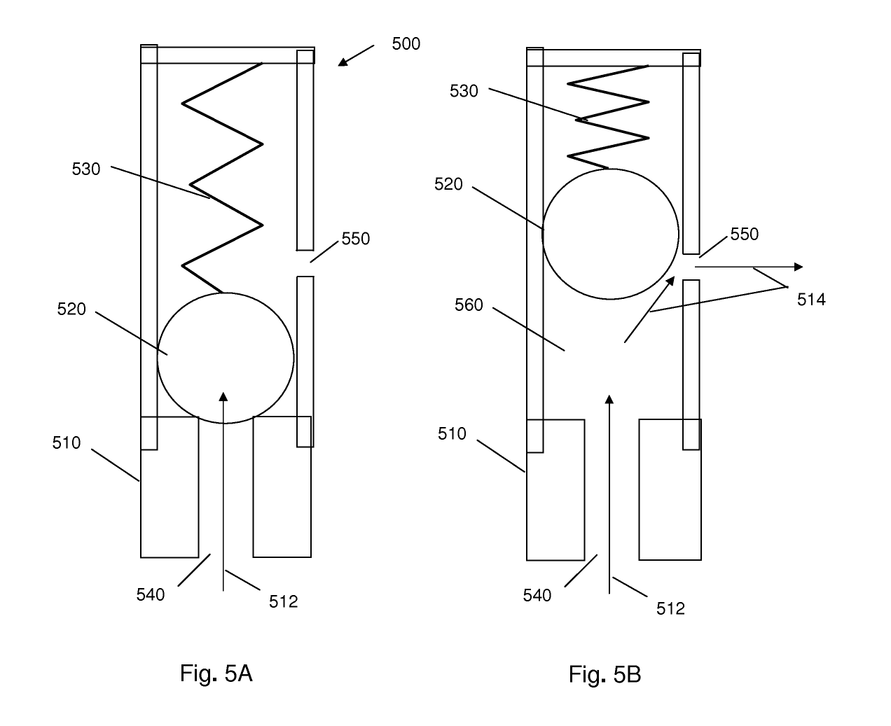

Reference is now made to FIG. 4 depicting a schematic diagram illustrating an exemplary pulsating high-pressure gas system 400 for stimulating material movement according to embodiments of the present invention. According to embodiments of the present invention, system 400 may be similar to system 100 depicted in FIG. 1. Additionally pulsating system 400 my include pulsators 410, situated at the openings 190 of distribution hoses 180. Pulsator 410 may convert the flow of gas into pulsing flow. Pulsator 410 may be chosen from any know in the art pulsators capable of operating under gas pressures of 10 to 350 bar such as, for example, pulse valves manufactured by ASCO Numatics. A schematic diagram illustrating an exemplary pulsator 500, in the closed and opened conditions, is given in FIGS. 5A and 5B, respectively.

Pulsator 500 depicted in FIGS. 5A and 5B may be constructed of a housing 510, ball 520 and spring 530. Pressurized gas may enter pulsator 500 through opening 540 in the general direction indicated by arrow 512. When the pressurized gas reaches ball 520, in the closed position of pulsator 500 depicted in FIG. 5A, ball 520 resists the pressure and may not move due to the resistance applied by spring 530. As more gas flows through opening 540, pressure builds. As the gas pressure force overcomes the resistance force, ball 520 may move up along housing 510, as seen in FIG. 5B. When ball 520 moves above opening 550, pressurized gas may flow out of opening 550 in the general direction indicated by arrows 512 and 514. Because of this flow, a part of the energy of the gas turns into velocity and the pressure in chamber 560 drops. When the pressure force in chamber 560 falls below the force applied by spring 530, ball 520 moves back down and closes opening 550 terminating the flow of Gas. At this point gas pressure increases until ball 520 moves upwards and the cycle repeats. Spring 530 parameters and ball 520 size may be adjusted so as to cause ball 520 to open and close opening 550 as long as pressurized gas is supplied, thus creating short cycles, or pulses, of pressurized gas bursts. Pulsing bursts of pressurized gas may be more effective in stimulating particle or material movement or in cleaning deposits buildup. Spring 530 and ball 520 parameters may be adjusted so as to facilitate gas pulses of, for example, 1-10 seconds.

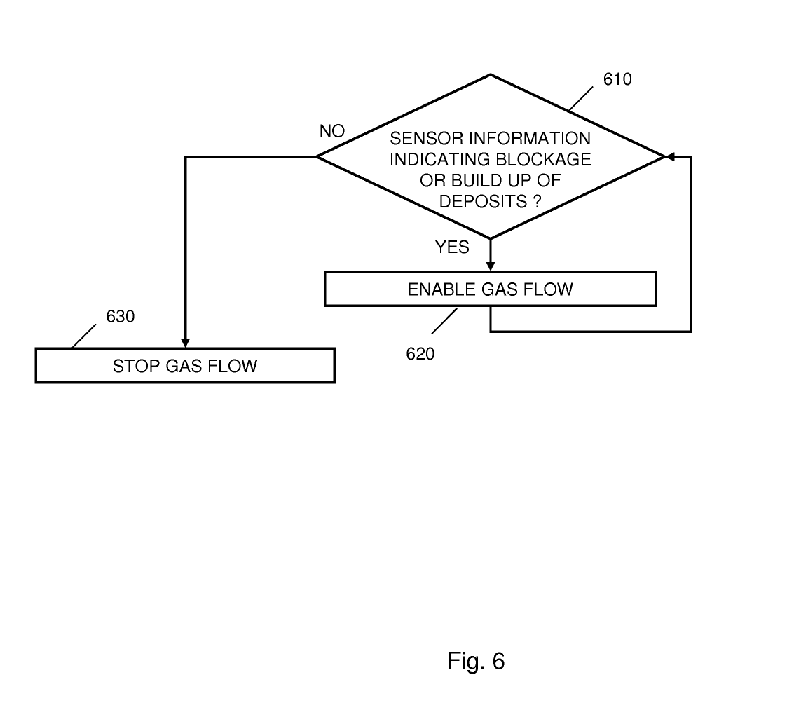

Reference is now made to FIG. 6 which is a flowchart illustration of an algorithm for operating a high-pressure gas system, according to embodiments of the present invention, which may be used, for example, in conjunction with system 300 depicted in FIG. 3.

The algorithm may be a computer program product stored on a non-transitory tangible computer readable storage medium. The computer program may include code for operating high-pressure gas system. The code may include instructions for opening and closing valve or tap 150. For example, it may be determined whether sensor information was received, indicative of a blockage in a vessel. This can be obtained, for example, by monitoring the pressure within the vessel, and determining whether a pressure threshold was reached which is known to be indicative of a blockage. Alternatively, other parameters may be sensed to facilitate arriving at a conclusion that the flow of deposits in the vessel is interrupted or that cleaning is needed 610. If the flow of deposits in the vessel is interrupted or cleaning is needed, flow of gas may be enabled 620, typically, in predefined cyclic scheme. The situation within the vessel may be monitored substantially continuously, and the cyclic flow of gas may be stopped if the problem is resolved 630.

Some embodiments of the present invention may be implemented in software for execution by a processor-based system, for example, processor 306. For example, embodiments of the invention may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A high pressure gas system for stimulating material movement within a vessel, the system comprising:
a hose network comprising a plurality of distribution hoses branching from a central hose, far ends of the distribution hoses connected to openings provided on a wall of said vessel; and
a high pressure gas supply system for supplying pressurized gas to said hose network;
wherein the system is designed to generate periodic gas blows into said vessel through said plurality of distribution hoses.

2. The system of claim 1, wherein said high pressure gas supply system comprises:
a valve connected to said hose network;
an actuator for opening and closing said valve; and
a gas receiver connected to said hose network through said valve.

3. The system of claim 2, comprising a timer and a solenoid configured to control operation of said actuator.

4. The system of claim 2, comprising a controller configured to control operation of said actuator.

5. The system of claim 2, comprising:
storage medium for storing computer executable program including code for operating the system for high pressure gas burst; and
a processor for executing the computer executable program.

6. The system of claim 1, further comprising:
a plurality of flow restrictors, each connected to one of the far ends of the distribution hoses.

7. The system of claim 6, wherein the flow restrictors include pulsators.

8. The system of claim 1, wherein the pressure of said pressurized gas ranges between 30 to 350 bar.

9. The system of claim 1, comprising a sensor adapted to sense a physical parameter associated with the operation of said hose network.

10. The system of claim 9, wherein said sensor is selectable from a list comprising:
pressure sensor, flow sensor and proximity sensor.

11. A method for stimulating material movement within a vessel, the method comprising:
providing a house network comprising a plurality of distribution hoses branching from a central hose, far ends of the distribution hoses connected to openings provided on a wall of said vessel; and
supplying pressurized gas to said hose network and generating periodic gas blows into said vessel through said plurality of distribution hoses.

12. The method of claim 11, wherein the generation of periodic gas blows includes generating periodic gas blasts into the vessel.

13. The method of claim 12, comprising using flow restrictors provided at the far ends of the distribution hoses to generate the gas blasts.

14. The method of claim 13, wherein the flow restrictors include pulsators.

15. The method of claim 11, comprising:
operating a valve connected to the hose network using an actuator; and
connecting a gas receiver to said hose network through the valve.

16. The method of claim 11, wherein the supplying of the pressurized gas comprises supplying pressurized gas under pressure in the rage between 30 to 350 bar.

17. The method of claim 11, comprising using a sensor to sense a physical parameter associated with the operation of said hose network.

18. The method of claim 17, wherein said sensor is selectable from a list comprising:
pressure sensor, flow sensor and proximity sensor.
